(19) United States
(12) Patent Application Publication
(10) Pub. No.: US 2014/0268380 A1
(43) Pub. Date: Sep. 18, 2014

(54) Adaptively Correctable Light Weight Mirror

(71) Applicant: Andrei Szilagyi, Rancho Palos Verdes, CA (US)

(72) Inventor: Andrei Szilagyi, Rancho Palos Verdes, CA (US)

(21) Appl. No.: 14/214,441

(22) Filed: Mar. 14, 2014

Related U.S. Application Data
(60) Provisional application No. 61/786,127, filed on Mar. 14, 2013.

(51) Int. Cl. G02B 7/182

(52) U.S. Cl. CPC G02B 7/182
USPC 359/846

(57) ABSTRACT

A light weight minor comprising a reflecting element adapted to receive shape adjustments or corrections from an actuated frame. Shape adjustments may be as simple as a uniform curvature, although saddle or higher order shapes are also possible. The frame may execute such adjustments by varying tension or by torsion, with variations applied either locally or uniformly. The frame may be configured to contact a membrane reflector either from one or both sides. Thermal and piezoelectric examples of actuation means are provided along with methods of controlling the shape of said mirrors. To suppress the occurrence of possible vibrations, said mirrors are also provided with eddy current vibration damping means.

### RELATED APPLICATION

This invention claims the benefit of U.S. Provisional Application No. 61/786,127 filed Mar. 14, 2013, the contents of which are incorporated by reference in their entirety.

### GOVERNMENT SUPPORT

Not applicable

### BACKGROUND OF THE INVENTION

1. Field of Application

This invention relates generally to the field of optical components and particularly to light weight adaptive mirrors.

2. Description of the Prior Art

A plate bounded by a circle, ellipse or other contours, usually supported by its edges and coated with a reflective layer on a planar side forms a flat mirror, a very common optical component. This component is typically intended to change the direction of optical waves, with the flatness attribute needed in order to prevent changes in the shape of the wave front. For example, an optical system with a generally circular cross section might use an elliptical mirror to divert the rays at 90°. Such a minor might be the key component in a scanning assembly, as described in a co-pending application (Szilagyi, “Slope-Following Precision Drive,”, U.S. Provisional Application No. 61/786,220 filed Mar. 14, 2013). Depending on the application, the primary flatness requirement may introduce stringent secondary requirements, to wit:
specialized substrate materials such as ultra low thermal expansion glass,
significant substrate thickness (hence substantial mass) to achieve adequate stiffness
careful and slow polishing procedures for high quality surface
low stress reflective coating
thermally matched supports
skillful assembly and handling
sufficient warm-up time to allow the massive interior to reach steady state

If the minor is also required to be relatively light—for instance by application in space—additional complications and expense are introduced by a light-weighted or ribbed back-side stiffening structure, as known in the prior art. Although light-weighting has succeeded in reducing the mass of large mirrors, the remaining structural features such as honeycombs and ribs continue to contribute a large fraction of optical system mass and fabrication cost. To continue progress in the field of light weight mirrors, two technological directions have emerged to lead the way: membrane or pellicle optics and adaptive optics, often pursued jointly.

Membrane optics have been the subject of much technological development in recent years because of their promise of affordable large aperture mirrors, windows and filters as well as their possible space deployment in light weight systems (see e.g., Wilkes, et al “A Review of Membrane Optics Research”, AFRL-DE-PSTM-2005-1002, 12 Apr. 2005, Marker et al.; “Large lightweight optical quality windows and filters”, Proc. SPIE 5553, Advanced Wavefront Control: Methods, Devices, and Applications II, 213 (Oct. 12, 2004) and DARPA Tactical Technology Office, “Membrane Optic Imager Real-Time Exploitation (MOIRE)”).

Literature reports (for instance in Marker et al. (2001), “Fundamentals of Membrane Optics,” in Gossamer Spacecraft: Membrane/Inflatable Structure Technology for Space Applications, AIAA Progress in Astronautics and Aeronautics Series (C. H. Jenkins, ed.), vol. 191, Chapter 4, as well as in de Blonk, “Optical-Level Structural Modeling of Membrane Mirrors for Spaceborne Telescopes”, Ph.D. Thesis, MIT, June 2003, Ohmart, “Device for reflecting and refracting radiant energy”, U.S. Pat. No. 504,890, Sep. 12, 1893 and Pajes, “Curved reflector”, U.S. Pat. No. 2,952,189, Sep. 13, 1960) of polymer membrane actuation are found primarily in relation to parabolic minors, often using pneumatic inflation to achieve their final shape. An important case arises where the boundary is also being controlled, sometimes manually (see Moore et al. “Design and Testing of a One-Meter Membrane Mirror with Active Boundary Control”, AFRL-DE-PS-TP-2006-1006, 1 Aug. 2005, Marker et al., “Active edge controlled optical quality membrane minor”. U.S. Pat. No. 6,113,242, Sep. 5, 2000, Chapter 8 in Eric John Ruggiero, “Modeling and Control of SPIDER Satellite Components”, Ph.D. Dissertation, Va. Polytechnic Institute, Jul. 29, 2005, Dan K. Marker, James M. Wilkes, Eric J. Ruggiero, and Daniel J. Inman, “Membrane Adaptive Optics”, AFRL-DE-PS-TP-2006-1008, 1 Aug. 2005 and Micah J. Solter, “A Prototype Actuator Concept For Membrane Boundary Vibration Control”, NASA/CR-2005-213252, February 2005). In spite of the advances achieved heretofore in the art, many limitations remain including:
Massive support structures,
Restrictive and difficult to transport actuation means such as pneumatic pumps with associated plumbing
Awkward membrane anchoring means such as catenary boundaries joining relatively widely separated anchoring points, etc.
   Such limitations are overcome in the present invention by limiting membrane deflections, using slender frames and providing continuously or nearly continuously distributed actuation. The present invention also provides correctable light weight mirrors which do not require pre-tensioning because they are constructed with flexible non-membrane reflective sheets.

### References Cited

### U.S. PATENT DOCUMENTS

Andrei Szilagyi, “Slope-Following Precision Drive,”, U.S. Provisional Application No. 61/786,220, concurrently filed Mar. 14, 2013
Eli C. Ohmart, “Device for reflecting and refracting radiant energy”, U.S. Pat. No. 504,890, Sep. 12, 1893 Wolf Szmul Pajes, “Curved reflector”, U.S. Pat. No. 2,952,189, Sep. 13, 1960
Dan K. Marker et al. “Active edge controlled optical quality membrane mirror”. U.S. Pat. No. 6,113,242, Sep. 5, 2000
Stanford Pavenick, “Heat shrunk plastic film mirror”, U.S. Pat. No. 3,936,159, Feb. 3, 1976

### Other References:

James M. Wilkes, Dan K. Marker, “A Review of Membrane Optics Research”, AFRL-DE-PSTM-2005-1002, 12 Apr. 2005
Dan K. Marker; Ethan Holt; Brian G. Patrick; David Sheikh; James D. Moore, Jr.; James R. Rotge;
James M. Wilkes, “Large lightweight optical quality windows and filters”, Proc. SPIE 5553, Advanced Wavefront Control: Methods, Devices, and Applications II, 213 (Oct. 12, 2004)
DARPA Tactical Technology Office, “Membrane Optic Imager Real-Time Exploitation (MOIRE)”
Marker, D. K., Wilkes, J. M, Carreras, R. A., Rotge, J. R., Jenkins, C. H., and Ash, J. T. (2001), “Fundamentals of Membrane Optics,” in Gossamer Spacecraft: Membrane/Inflatable Structure Technology for Space Applications, AIAA Progress in Astronautics and Aeronautics Series (C. H. Jenkins, ed.), vol. 191, Chapter 4
Brett J. de Blonk, “Optical-Level Structural Modeling of Membrane Mirrors for Spaceborne Telescopes”, Ph.D. Thesis, MIT, June 2003
James D Moore, Brian G. Patrick, Surya Chodimella, Dan K. Marker, Brett de Blonk, “Design and Testing of a One-Meter Membrane Mirror with Active Boundary Control”, AFRL-DE-PS-TP-2006-1006, 1 Aug. 2005
Chapters 7 and 8 in Eric John Ruggiero, “Modeling and Control of SPIDER Satellite Components”, Ph.D. Dissertation, Virginia Polytechnic Institute, Jul. 29, 2005
Dan K. Marker, James M. Wilkes, Eric J. Ruggiero, and Daniel J. Inman, “Membrane Adaptive Optics”, AFRL-DE-PS-TP-2006-1008, 1 Aug. 2005
David C. Dayton, Justin D. Mansel, John D. Gonglewski, Bob Praus, “Characterization Of A Novel Electro-Static Membrane Mirror Using Off-the-Shelf Pellicle Membranes”, International Workshop on Adaptive Optics in Industry and Medicine, Galway, IE, Jun. 12, 2007
Justin D. Mansel, “Beam shaping for relay mirrors”, Proceedings of SPIE, Laser beam shaping. Conference No 7, San Diego Calif., 2006, vol. 6290
Micah J. Solter, “A Prototype Actuator Concept For Membrane Boundary Vibration Control”, NASA/CR-2005-213252, February 2005
Henry A. Sodano, “Development of Novel Eddy Current Dampers for the Suppression of Structural Vibrations”, Ph.D. Dissertation, Virginia Polytechnic Institute, Jul. 29, 2005

### SUMMARY OF THE INVENTION

It is an object of the present invention to provide a reflective membrane suitable for use on or off axis, with flatness improved by passive means. It is a further object of this invention to provide membrane minors with surface figure correctable or adjustable by adaptive control of their boundary. Another object of this invention is to provide membrane reflectors with enhanced immunity against thermal disturbances. Yet another object of this invention is to provide membrane reflectors with convenient means for damping vibrational disturbances. It is also an object of the present invention to provide slender, light weight, non-membrane mirrors with surface figure adaptively correctable or adjustable.

### BRIEF DESCRIPTION OF THE FIGURES

The features and advantages of the present invention will be more fully described below and illustrated by means of the accompanying figures wherein like numerals refer to similar elements.

FIG. 1 shows a cutaway view of membrane mounted on a uniform width frame.

FIG. 2 is a sectional view of a simulated membrane showing that tension induces torsion into the frame and bowing into the mirror shape.

FIG. 3 illustrates the limited effect that frame thickness exerts on the torsional deformation induced by membrane tension.

FIG. 4 shows that frame stiffness uniformity is insufficient to counteract tension driven frame torsion and membrane deformation.

FIG. 5 shows that a symmetrical and balanced arrangement of two membranes—one on each side of a frame—can suppress frame torsion but still cannot prevent membrane deformation. To avoid clutter, only one of the membranes is shown along with the upper half of the frame.

FIG. 6 shows that even when the balanced arrangement of FIG. 5 is supplemented by a stiffer frame, membrane bowing is not improved.

FIGS. 7A-7H are simulations of membranes with progressively smaller tensions and maximum deflections.

FIG. 8 is a graphical summary of the radial deflection profile variation with membrane tension, as extracted from the simulations of FIG. 7.

FIG. 9 illustrates a preferred embodiment wherein symmetrical support of the membrane effectively suppresses tension driven deformation.

FIG. 10 shows in a preferred embodiment that actively controlled frame torsion can readily control membrane curvature.

FIG. 11 shows a preferred embodiment producing or cancelling astigmatic aberrations by inducing controlled frame torsion.

FIG. 12 depicts a thermally controlled embodiment in a sectional perspective view

FIG. 13 illustrates a piezoelectrically controlled embodiment in a sectional perspective view.

FIG. 14 illustrates an alternative piezoelectrically controlled embodiment in a sectional perspective view.

FIG. 15 shows a preferred embodiment combining torsion controlled shape and eddy current vibration damping.

FIG. 16 is a sectional perspective view of a simulated thermally actuated flexible mirror embodiment with a 2 degree Celsius temperature difference between a bottom heater and the ambient temperature.

FIG. 17 shows the embodiment of FIG. 16 with the sign of the 2 degree temperature reversed.

FIG. 18 is a more detailed sectional depiction of a flexible mirror embodiment

### DESCRIPTION OF MEMBRANE MIRRORS PREFERRED EMBODIMENTS

Figures provided herein are not representative of the prior art, but serve to explain the concepts incorporated in some of the membrane-based preferred embodiments without restricting the size or relative dimensions of their features. It is important to note that several of these figures show the results of computational simulations by finite elements modeling (FEM) and analysis (FEA), where deformations have been artificially exaggerated in order to enhance understanding of physical behavior. Thus, actual construction of the minors under discussion will exhibit much smaller deformations (often less than the thickness of the membrane) which may be difficult to discern with the naked eye, though deployment in an optical system would clearly reveal the simulated effects. It is also helpful to note that the simulations depicted below account for possible large deflection and geometric nonlinearities in three dimensions, thus going beyond the capabilities of most analytical treatments.

FIG. 1 depicts in a cutaway format the structure of a hypothetical elliptical membrane minor, such as might be considered for use in a 90° scanning system. The membrane 1 is mounted on an initially flat slender frame 2 of uniform cross section. FEA simulation of a quarter model delimited by the semi major and semi minor symmetry axes shows (FIG. 2) that such a mirror will exhibit a bowed surface even though the membrane might have been stretched initially to a flat uniform tension state. Again, in this and several other figures hereinbelow, the surfaces of interest are shown with their deflection exaggerated in proportional measure in order to better visualize their salient features. In addition, the deflected surfaces are decorated with contours of constant deflection, in the same manner as contours of constant elevation are used in connection with topographic maps. We also note that:
The frame has undergone torsion
The membrane curvatures vary with direction
The contours of constant deflection do not match the frame outline, signifying a non-uniform frame torsion

Some of the non-uniform frame torsion may be due to the effective variation in stiffness associated with the elliptical shape. In FIG. 3 we demonstrate that increasing the stiffness of the frame near its more compliant region by increasing its thickness does not improve the deflection of the membrane.

The possibility that frame stiffness non uniformity is responsible for membrane deformation is eliminated by the simulation in FIG. 4, where the frame is configured with an axisymmetric, circular shape. Torsion of the frame due to membrane tension and bowing of the latter are clearly seen in this exaggerated illustration. It appears that frame torsion might be the proximal cause of membrane bowing. To balance the tendency of the cross section to rotate, a simulation including a second membrane, identical to the first, was carried out, wherein the second membrane is bonded to the other axial surface of the frame. A plane perpendicular to the optical axis, bisecting the frame would then be a plane of minor symmetry. That symmetry allows us to analyze only half of the model on one side of that plane. As seen in FIG. 5, the frame is no longer rotating; however, no progress is seen regarding membrane flatness. Similarly, no progress in flatness results from also thickening the frame, as FIG. 6 documents. Moreover, the radial slope of the membrane in the vicinity of the frame is apparently quite different from the slopes of the frame's axial surfaces. Except for the inventive concepts to be presented below, further manipulation of the frame slope and attempts to make the frame flatter, appear to be doomed to failure.

When viewing the double membrane case of FIG. 5, it is apparent that the interior portion of the membrane can act as a relatively flat clear aperture, in spite of the sloped peripheral region. The appearance of a flattened central region is a sensitive consequence of geometric nonlinearities occurring during large deflections of stretched membranes. Such a central region may be beneficial in a reflective optical system. In this regard, it is noteworthy that in each of the preceding cases the edge restraint was applied from one side of the membrane. It is also noteworthy that the membrane surface slope beginning from the inner edge of the frame toward the center persists over a finite range of radii. This is in spite of the tension which would otherwise tend to flatten the membrane. This means that bending stiffness is operative, although it is normally assumed to be negligible in the case of membranes. The fact that the membrane is mounted under tension to a relatively stiff frame means that a shear force present in the membrane over the frame surface is converted to an applied moment acting on the membrane cross section near the inside edge of the frame. The applied moment acts to deflect the membrane. When this deflection is relatively small (i.e. for low membrane tension) the resulting shape of the membrane may be nearly spherical. At larger tensions, it becomes energetically favorable to reduce tension and bending over a large central area by flattening, at the expense of a larger curvature appearing over a narrow circular region near the boundary. FIGS. 7A through 7H illustrate this behavior in a simulated progression of tension values from large to small, with the radial profiles compared in FIG. 8. This sequence of figures is annotated with the applicable tension and with the maximum deflection (in arbitrary units.)

For stretched membranes bonded on one side to a frame we reach the following conclusions:
At large tension, the membrane departs significantly from planarity, especially near the edge. The departure may be optically significant resulting in many waves of wavefront error. There is a potentially large central region with good flatness. The quality of the central region is dependent on the quality of the frame and of the membrane. If the frame has active shape control that quality can be corrected after manufacturing, as will be described in embodiments hereinbelow.
At lower tension the membrane assumes a nearly spherical shape with curvature low enough to permit large distance focusing. When the frame is capable of a small radial modulation, for instance by controlled thermal expansion or by actuated torsion, the resulting membrane curvature becomes adjustable and the focal length can be tuned as needed for large distance. This represents a preferred embodiment of the present invention.

A better approach to achieving a flat membrane shape is to prevent the bowing from occurring in the first place. FIG. 9 illustrates a preferred embodiment wherein flatness of the membrane is passively favored by using identical frames s on both sides of the membrane 1. Since stretching is supported symmetrically, no net bending moment is applied passively, so the membrane is mounted in optimal conditions. Manufacturing errors and environmental factors, however, may still be present, so methods and means of active control are still needed and provided in embodiments which follow.

FIGS. 10 and 11 illustrate a preferred embodiment of the present invention capable of modulating the shape or cancelling shape errors of a membrane mirror. A key feature of this embodiment is the shape of the frame 2. The rectangular cross section arranged with the long dimension in the axial direction allows frame to bend more easily in the plane of the membrane. Another key feature of this embodiment is the method of applying a controlled torsion to the frame in order to exert a moment or torque onto the membrane boundary. In FIG. 10, such torsion creates a simple curvature. When the torsion is uniformly distributed around the frame, the result is an axisymmetric membrane shape, such as a spherical cap or a partially flattened spherical cap. When the amount of torsion is varied around the circumference, a large variety of shapes is enabled, depending on the number and distribution of actuators on the frame as well as the drive amplitude supplied to each. As an example, FIG. 11 documents the production of an astigmatic shape by alternating the sign of torsion at 90° intervals around the perimeter.

Active control of membrane minor shape such as illustrated herein is best served by providing the frame with sufficient compliance so that actuators of modest capacity can be employed. This is particularly important in space-based applications where low mass and low power consumption have a great impact on mission feasibility. The rectangular cross sections emphasized so far was chosen because of its compliance with respect to bending and twisting deformation. Although the easy bending direction (in a plane cutting across the narrow dimension of the cross section) does not itself permit the frame to deform out of plane, its twisting ability does. The easy bending direction, however, is still beneficial, since it facilitates equalization of membrane tension in the following way. The mounting process involves stretching the membrane using a relatively larger stretching tool as already known in the art. Such tools commonly introduce unintentional tension non uniformities. If the stretching tool is sufficiently large compared to the mounting frame, tension non-uniformities are reduced, though perhaps not sufficiently. In a preferred embodiment of the present invention, top and bottom frame elements 2 with suitable compliance are brought together to capture and bond the membrane 1 therebetween. Subsequently, the portion of the membrane external to the frame is severed, thereby transferring the tension load from the stretching tool to the frame. If, owing to the residual non-uniformity, one direction within the membrane experiences higher tension, the frame's in-plane compliance allows it to slightly adjust its shape elastically by reducing its radius in the region of high tension while increasing it in the region of lower tension. According to the inventive concepts disclosed herewith, the result of this adjustment is a more nearly uniform tension. Transferring load from high to low tension areas, therefore, is achieved by using a frame with sufficient bending compliance, and sufficient compressive stiffness. This combination of attributes may be achieved with ordinary light engineering materials, including, for instance, aluminum, titanium, fiber-based composites and some ceramics, when configured according to the teachings of this invention.

To achieve uniform bowing of the membrane, it may be sufficient to rotate the frame cross section uniformly along its entire circumference. In one embodiment, such a rotation could be accomplished by introducing a source of heat near one axial face of the frame. The resulting axial thermal gradient would cause a greater thermal expansion in the radial direction of the part of the frame nearest the heat source. Geometrically, this expansion manifests itself as frame torsion.

Additional capability can be gained if frame torsion can be controlled with more degrees of freedom. An example was already given in FIG. 11 for the case where an astigmatic shape is produced either to correct a wavefront or to compensate for manufacturing imperfections. In a preferred embodiment, such a shape could be introduced through heating of an axial surface of the frame, but this time the heating would be directed to localized portions of the circumference in order to customize the result to a desired non-axisymmetrical shape. Addressable sources of heat are known in the art and could be conveniently configured for this application, as shown in FIG. 12, in the form of a flexible circuit with multiple external connections driven by electrical current sources under computer control. Injecting differing amounts of heat (differential driving) to both localized axial regions across the membrane would give rise to membrane bowing out of plane and forms an inventive method of operation of this embodiment. If, instead, equal amounts of heat are supplied (common mode driving) to both localized axial regions across the membrane would give rise to a change in membrane tension and forms another method of operation. Selective common mode driving may be used if bending compliance of the frame does not equalize tension sufficiently. It may also be used to counteract the effect of asymmetric thermal disturbances from the environment. Common mode driving of all the heating regions may be used to increase the average tension in the membrane and forms yet another method of operation of this embodiment. This method may be particularly effective in a preferred embodiment (not illustrated) incorporating a minor backing arranged in spaced relationship from the membrane on its non-optical side. Such a backing layer may be used to extract some of the waste heat from the system by radiative transfer from the back of the membrane. Preferably, the membrane material can be selected to have a relatively high emissivity and the backing material to have a relatively high absorptivity. Preferably for a flat minor, the extraction of heat from the backing layer should be concentrated near its center. This way, a radial thermal strain gradient would help ensure that the center of the mirror cannot have excess material to bulge outwardly. Extraction of heat from the center of the backing layer can be encouraged by having the central region painted black and the outer region painted white or made reflective.

The external connections, as conceived in this embodiment, may be constructed with strain relieving features, in order to minimize mechanical disturbances from the support structure. Preferably, the number of addressable regions should be equal to or greater than the number of side lobes present in the highest order term of a Zernike decomposition of a worst case desired membrane shape.

By virtue of the relatively slow process of heat transfer, thermal actuation lends itself to correction of static or relatively slowly changing errors. For instance, thermal gradients experienced by an optical system in earth orbit which vary due to changing exposure to the sun, earth and deep space background, may introduce such slowly varying errors. For more dynamic conditions, other actuation methods may be better. The preferred embodiment of FIG. 13, for example, uses piezoelectric strips 4, wafers or patches bonded to the frame above and below the membrane. Piezoelectric materials of this type are known in the art and available commercially in various forms such as ceramic wafers or macro fiber composites (MFC). A single piezoelectric strip upon bonding to the frame becomes operable as a unimorph, one of a several types of electrically driven bending actuators.

Strips may be mounted on the inside, the outside, or both inside and outside of the frame without departing from the inventive scope of this embodiment. Likewise, preassembled bender strips may be bonded to the frame without departing from the inventive scope of this embodiment. Also within the scope of the embodiment, as shown in FIG. 14, the rectangular cross section of the frame 2 may be arranged with the long dimension radially aligned and with the piezoelectric actuators 4 bonded to the axial surfaces.

As in the case of thermal actuation discussed above, the frame undergoes torsion when unimorphs or benders above and below the membrane are driven differentially, according to an inventive method of operation. Likewise, common mode activation may be used to enhance membrane tension uniformity, according to another method of operation. Judicious choice of the driven unimorphs and their drive levels can produce a wide variety of membrane shapes, according to yet another method of operation of this embodiment. Unlike the thermal approach, piezoelectric actuation is very fast and could be used for dynamic correction of certain wavefront errors, notably those with Zernike modes lacking interior peaks, or those with one or a few low amplitude interior peaks

Operation of membrane minors in environments subjected to mechanical vibrations introduces additional challenges both on earth and in space. In particular, suppression of vibrations may be a potentially critical requirement, especially for a scanning system which may exhibit membrane modes either during or after a scanning operation. The published literature shows a variety of methods for vibration suppression, such as:
passively using a fluid (e.g., gas) filled chamber behind the membrane (for example, see Chapter 7 in Eric John Ruggiero, “Modeling and Control of SPIDER Satellite Components”, Ph.D. Dissertation, Virginia Polytechnic Institute, Jul. 29, 2005. This is inconvenient in space due to the need for make-up fluid,
passively using eddy currents induced by membrane movement in a static magnetic field (e.g. see Henry A. Sodano, “Development of Novel Eddy Current Dampers for the Suppression of Structural Vibrations”, Ph.D. Dissertation, Virginia Polytechnic Institute, Jul. 29, 2005,)
actively using out-of-plane actuation, or
actively using feedback-controlled eddy currents produced by an electromagnet

FIG. 15 shows in cross sectional view a preferred embodiment which adds to the membrane shape control disclosed above a capability to damp membrane vibrations using eddy currents. The key feature of this embodiment is the arrangement of a current carrying coil 5 just outside of the perimeter and substantially coplanar with the membrane 1 coated with an electrically conductive reflective layer. When the coil is energized, a substantially axial magnetic field is created transversally to the membrane. Since any vibrations consist of axial motion, a distribution of eddy currents is induced in the conductive layer. The eddy currents, in turn dissipate the vibration energy in the form of ohmic heating. The location of the coil 5 just outside the membrane 1 is particularly advantageous since it allows minimization of the coil mass while covering the entire minor surface.

If the presence of vibration is sensed, anticipated or otherwise known, the current-carrying coil may be selectively energized during that time only, thereby saving electrical energy. This feature would be particularly valuable for a space deployment of a membrane minor, and forms an inventive method of operation of the vibration damper.

Although, the embodiment of FIG. 15 was described in conjunction with a thermally actuated membrane, other methods of actuation would also be within its scope.

Although some of the embodiments of the present invention were depicted for the case of a circular membrane, the invention applies also to other shapes, notably elliptic.

### Description of Flexible Mirrors Preferred Embodiments

As was discussed above, the presence of a bending moment can result in non-negligible deflection even in the case of relatively thin membrane mirrors. The effect will be greatly increased when the thickness grows to the regime when we can no longer talk about membranes but rather about flexible mirror sheets or plates. Their flexibility would normally make such sheets still unsuitable for precision optics. However, that same flexibility coupled with a thermal stimulus, can be beneficially exploited, as illustrated in the preferred embodiment of FIGS. 16-18.

In simulating this embodiment, thermal boundary conditions were applied in two ways resulting in the shapes depicted in FIGS. 16 and 17. In the former case heat was applied to the lower jaw 7 of the clamp like frame, while in the latter case heat was applied to the upper surface of the flexible minor sheet via a non-contact upper heater 12. All the other bodies remained at the ambient temperature or close to it depending on the amount of heat flowing from the respective heater. The resulting thermal gradient and thermal expansion gradient manifest themselves in the bowing shown. The mirror 6 is secured from the edges. An example of mounting technique appears in FIG. 18.

The mounting clamp frame features kinematic features such as a centering o-ring 9 on a grooved side of the mirror and an axial clamping o-ring 10 in contact with an un-grooved side of the mirror. The absence of a groove on one side of the mirror ensures that the upper jaw 8 contributes essentially zero moment restraint. The frame consists of ring-like jaws 7 and 8 adapted to receive the o-rings in suitably sized o-ring glands. Fastening means for securing the two jaws of the frame are not shown because they are well known in the art. Also illustrated are sources of controlled heat needed to create the desired level of mirror bowing. They may be conveniently configured as concentrically disposed and independently controlled resistive circuits forming bottom and upper heaters. The fabrication of such circuits is well known in the art. It is also known that such circuits may be subdivided into a larger number of smaller, independently controllable (not shown) circuits in order to provide fine scale control of heat distribution. This way, either imperfections in the fabrication of components or external disturbances may be compensated for in order to more closely achieve the desired mirror shape. The selection of material is important to the operation of this embodiment. In particular the o-ring interfacing with the grooved side of the flexible mirror should be made of a sufficiently stiff material so as to transmit radial forces and reactions between the lower jaw and the flexible minor. A relatively rigid plastic material may suffice for this purpose. Alternatively an array of metal ball bearings may be substituted for that o-ring to provide excellent radial force communication. The top o-ring, however is best fabricated from materials common to such parts, such as elastomeric polymers.

In operation, heating the lower jaw causes its radial dimension to grow, thus exerting a tensile stress on the bottom surface of the minor, causing it to become convex. Conversely, heating the upper surface of the mirror via the upper heater, causes the upper side of the mirror to expand, while the bottom side is restrained radially by the bottom jaw. This causes the bottom mirror surface to become concave.

I claim:

1. An apparatus for controlling the small amount of curvature of a pre-tensioned membrane minor, comprising
a. A membrane having first and second sides,
b. Having at least one of said first and second sides coated with a reflective coating
c. Said membrane being uniformly pre-stretched at a relatively low level of tension,
d. Either one of said first and second sides being bonded under said relatively-low-tension onto a generally circular frame
e. Said frame being capable of controlled increases or decreases of said membrane tension, thereby causing small changes in membrane curvature

2. The apparatus of claim 1 wherein said membrane tension increase or decrease is achieved by adjusting the temperature of said frame

3. A variable focal length optical apparatus comprising at least one apparatus constructed according to claim 1, preferably sharing the optical axis thereof, wherein the focal length is adjusted by deliberately controlling the curvature of said membrane minor.

4. A method of controlling the curvature of a mirror configured according to claim 2 comprising the steps of:
a. Mounting the apparatus of claim 2 in an optical system
b. Exposing the reflective side of said minor to optical or electromagnetic radiation
c. Examining the reflected radiation by sensing means adapted to output a curvature-indicating sensor signal
d. Transmitting said sensor signal to control means adapted to produce a control signal based on comparing said sensor signal to a reference or a programmed target value
e. Transmitting said control signal to heating means coupled to said frame in order to adjust its temperature to the level needed for the desired curvature.

5. An apparatus for controlling the shape of membrane mirrors comprising:
a. A membrane having first and second sides,
b. Having at least one of said first and second sides coated with a reflective coating
c. Said membrane being uniformly pre-stretched at a level of tension low enough to prevent frame buckling,
d. Each of said first and second sides being bonded under said tension to symmetrical and mutually aligne first and second frames

6. The apparatus of claim 5 wherein said combined first and second frames are mechanically coupled to torsion actuation means continuously or discretely distributed, around the circumference of at least one of said first and second frames, said means being jointly or selectively addressable and driveable, and wherein said torsion actuation means are configured to rotate local cross sections of the frames around an axis perpendicular to said local cross section.

7. The apparatus of claim 6 wherein said frames have a combined rectangular cross section with the long dimension thereof oriented in a generally perpendicular direction to the surface of said membrane.

8. The apparatus of claim 6 wherein said frames have a combined rectangular cross section with the long dimension thereof oriented in a generally parallel direction to the surface of said membrane.

9. The apparatus of claim 6 wherein said torsion actuation means are distributed at a sufficient number of circumferential locations around the circumference of said frame to synthesize a surface deformation capable of cancelling a waveform deformation of maximal desired Zernike order.

10. The apparatus of claim 6 wherein said torsion means consist of heating means.

11. The apparatus of claim 10 wherein said heating means consist of flexible heater circuits.

12. The apparatus of claim 11 wherein said heater circuits have separately drivable heater portions.

13. The apparatus of claim 6 wherein said torsion actuation means consist of piezoelectric actuators or benders

14. The apparatus of claim 13 wherein said piezoelectric benders consist of integrated unimorphs configured as
a. a first array of electroded piezoceramic wafers conductively bonded directly to a first one of said two frames,
b. a second array of electroded piezoceramic wafers conductively bonded directly to the second one of said two frames,
c. wherein said frames are either fully electrically conductive or are coated with an electrically conductive coating
d. wherein said electroded piezoceramic wafers each have conductive metal electrodes deposited in intimate contact with each of two main surfaces of said wafers
e. wherein a first one electrode from each wafer is in operative electrical communication with one of said electrically conductive frames
f. wherein a second one electrode from each wafer is in operative electrical communication with an external electrical control circuit
g. wherein a second electrical pole is connected to the frames and is shared among all of said piezoceramic wafers, and
h. wherein the polarization direction for all said wafers is consistently selected for all said wafers

15. A method of adjusting the curvature of a slender frame membrane minor comprising the steps of:
a. Configuring a slender frame membrane mirror according to claim 6
b. Uniformly driving at a first level the torsion actuation means for a first one of said two frames, and
c. Uniformly driving at a second level the torsion actuation means for a second one of said two frames
wherein said first and second level are generally different from each other

16. A method of adjusting the slope of a membrane minor locally near a particular location around the circumference thereof, comprising the steps of:
a. Configuring a slender frame membrane mirror according to claim 6
b. Near said particular location, changing by a first predetermined amount the drive level of a discrete actuator for a first one of said two frames, and
c. Near the same particular location, changing by a second predetermined amount the drive level of a discrete actuator for the second one of said two frames
wherein the sum of said two predetermined amounts is substantially equal to zero

17. A method of adjusting the tension of a membrane mirror locally near a particular location around the circumference thereof, comprising the steps of:
a. Configuring a slender frame membrane mirror according to claim 6
b. Near said particular location, changing by a first predetermined amount the drive level of a discrete actuator for a first one of said two frames, and
c. Near the same particular location, changing by a second predetermined amount the drive level of a discrete actuator for the second one of said two frames
wherein said two predetermined amounts are substantially equal to each other.

18. A method of controlling the shape of a slender frame membrane minor comprising the steps of:
a. Configuring a slender frame membrane mirror according to claim 6
b. Combining said slender-frame membrane minor with an optical system wherein sensing means provide feedback on the performance of the membrane minor
c. Connecting each of said discrete actuators to controller means adapted to receive signals from said sensor means and objective programming from a user, and further adapted to adjust drive signals to said actuator means in a closed feedback loop.

19. An apparatus for adjusting the curvature of a flexible mirror: comprising:
a. A flat flexible sheet having first and second generally flat sides,
b. Having at least one of said first and second sides coated with a reflective coating
c. Said sheet being supported by frame means
d. Said frame means comprising
i. axial clamping and radial locating features, and
ii. axial and radial heating means

20. The apparatus of claim 19 wherein both of said first and second sides are coated with a reflective coating.

21. The apparatus of claim 19 wherein said flexible sheet is configured as a circular disk.

22. The apparatus of claim 21 wherein said sheet is provided with a coaxial o-ring groove on a first one of said sides, adapted to receive and be located radially by an o-ring of said radial locating feature.

23. The apparatus of claim 22 wherein said o-ring is constructed of a relatively rigid material.

24. The apparatus of claim 22 wherein the function of said o-ring is served by a plurality of metal ball bearings of the same diameter.

25. The apparatus of claim 22 further comprising a second o-ring of said axial clamping feature, said o-ring adapted to contact the un-grooved second one of said first and second sides of said flexible sheet under a predetermined preload force, said contact occurring near the periphery of said flexible sheet.

26. The apparatus of claim 25 wherein said o-ring is constructed of a conventional elastomer.

27. The apparatus of claim 19 wherein said heating means is configured as at least one flexible heater circuit mounted onto said frame means and positioned in generally parallel and axially spaced relationship from said flexible sheet.

28. The apparatus of claim 27 wherein
a. said heating means comprises first and second separately controllable heating circuits located in concentric and spaced relationship from each other and from said flexible sheet
b. said first one of said heating circuits is limited in radial extent to a smaller radius than that of said flexible sheet, and it is spaced closest to said first side of the flexible sheet,
c. said second one of said heating circuits is annular in shape with an inner radius greater than that of said flexible sheet and it is spaced closest to said second side of the flexible sheet, and
d. said second side of the flexible sheet is reflectively coated

29. The apparatus of claim 28 wherein said two heating circuits are further subdivided into discrete and separately controllable heaters, sufficient in number to synthesize a surface deformation capable of cancelling a waveform deformation of maximal desired Zernike order.

30. A method of adjusting the curvature of a flexible mirror comprising the steps of:
a. Configuring a slender frame membrane mirror according to claim 19
b. Applying axial and radial heating to said flexible sheet to create therein axial and radial thermal gradients for inducing thermal bowing

31. A method of adjusting the curvature of a flexible mirror comprising the steps of:
a. Configuring a slender frame membrane mirror according to claim 28.
b. Applying a first predetermined drive level to a first one of said two heating circuits, and
c. Applying a second predetermined drive level to the second one of said two heating circuits
wherein at least one of said drive levels is non-zero, and wherein
d. Increasing said first drive level drives the mirror curvature more negative, or concave, while
e. Increasing said second drive level drives the minor curvature more positive, or convex

32. A method of controlling the shape of a flexible mirror comprising the steps of:
a. Configuring a flexible mirror according to claim 29
b. Combining said flexible minor with an optical system wherein sensing means provide feedback on the performance of the flexible minor
c. Connecting each of said discrete heaters to controller means adapted to receive signals from said sensor means and objective programming from a user, and further adapted to adjust drive signals to said heaters in a closed feedback loop.

33. The apparatus of claim 6 modified by
a. Coating at least one of said one or two sides of said membrane with an electrically conductive coating, and by
b. Adding eddy current means of suppressing vibrations

34. The apparatus of claim 33 wherein said eddy current means consists of
a. An electrical winding generally coplanar with the membrane producing a magnetic field generally perpendicular to said conductive coating,
b. Energizing means for driving a suitable electrical current through said winding, and
c. Control means for determining the magnitude and timing of vibration suppressing current drive
